(19) United States
(12) Patent Application Publication
(10) Pub. No.: US 2010/0110193 A1
(43) Pub. Date: May 6, 2010

(54) LANE RECOGNITION DEVICE, VEHICLE, LANE RECOGNITION METHOD, AND LANE RECOGNITION PROGRAM

(76) Inventor: Sachio Kobayashi, Saitama (JP)

Correspondence Address: ARENT FOX LLP, 1050 CONNECTICUT AVENUE, N.W., SUITE 400, WASHINGTON, DC, 20036, US

(21) Appl. No.: 12/513,425

(22) PCT Filed: Nov. 1, 2007
(86) PCT No.: PCT/JP2007/071326

§ 371 Date: May 4, 2009

(30) Foreign Application Priority Data
Jan. 12, 2007 (JP) 2007-004579

(51) Int. Cl. H04N 7/18

(52) U.S. Cl. 348/149

(57) ABSTRACT

A lane recognition device recognizes a lane along which a vehicle travels by detecting a lane mark provided on the road to define the lane, from an image of the road acquired via an image acquisition device mounted on the vehicle. The lane recognition device is equipped with an object detection unit which detects an object other than the lane mark existing ahead of the vehicle, and a lane mark detection unit which detects the lane mark on the basis of the data from which the area corresponding to the object detected by the object detection unit is removed. By doing so, when recognizing the lane along which the vehicle travels by detecting the lane mark from the image of the road, the recognition accuracy of the lane is improved by appropriately removing influence of the object other than the lane mark captured in the image of the road.

### BACKGROUND OF THE INVENTION

1. Technical Field

The present invention relates to a lane recognition device, a vehicle thereof, a lane recognition method, and a lane recognition program for recognizing a lane by processing an image of the road acquired via an imaging means such as a camera and detecting lane marks on the road.

2. Description of the Related Art

In recent years, there has been known a technique for detecting a lane mark such as a white line on a road where a vehicle travels, by acquiring an image of the surface of the road along which the vehicle travels with an imaging means such as a CCD camera mounted on the vehicle, processing the image of the road, and recognizing a lane (traffic lane) from the result of detection. On the basis of the information on the lane recognized by this technique, a steering control of the vehicle is performed or the information is provided to a driver, and the like. In this technique, for example, the device differentiates, with respect to a plurality of horizontal lines in the image of the road, luminance for each horizontal line from the left in the lateral direction, and extracts a point where luminance changes from dark to light (positive edge point) and a point where luminance changes from light to dark (negative edge point) on the basis of respective peak of the differential values. Then, a combination of edge points, in which the positive edge point and negative edge point appear in alternate order on each horizontal line and in which the edge points are arranged at intervals that seem to be appropriate for a white line, is extracted as a white line candidate. Then, a white line is detected among the extracted white line candidates on the basis of the positions thereof in the image.

At this time, when subjects other than the lane mark such as a preceding car or a pedestrian for example exists on the road ahead of the vehicle, such subjects other than the lane mark are also captured in the image of the road. Therefore, when the lane mark is detected by processing the captured image, information on the subjects other than the lane mark such as the preceding car is extracted together with the information on the lane mark. The information on the preceding car and the like is unnecessary information in the process of recognizing the lane. Further, because there may be cases in which the information on the preceding car and the like is difficult to distinguish from that of the lane mark, there is a possibility that this becomes the cause of erroneous recognition in the process of recognizing the lane. Therefore, there is proposed a technique of performing reasonable lane recognition by, for example, detecting the preceding car and restricting the image region for performing lane recognition process on the basis of the detected information (refer to, for example, Japanese Patent Laid-Open H07-117523 (hereinafter referred to as Patent Document 1)).

In the travel control device for a car of the Patent Document 1, the car travels at a low speed in a preset speed in the case where the preceding car does not exist, follow the preceding car while keeping a target distance between the cars in the case where the preceding car exists, and performs deceleration control when the high-speed subject vehicle catches up with the low-speed preceding car. In the travel control device, there is equipped a lane recognition means for recognizing a white line representing the lane along which the subject vehicle is traveling, on the basis of the image capturing the front of the subject vehicle. On the basis of the distance between the cars to the preceding car, the lane recognition means processes the image of a narrow processing area when the distance between the cars is short, and processes the image of a wider area in accordance with the increase in the distance between the cars.

However, as is the case in the device of the Patent Document 1, if the processing area is narrowed or expanded only in accordance with the distance between the cars, there may be a case where the processing area is set inappropriately. That is, the degree of the preceding car and the like becoming a noise in the detection of the lane mark varies in accordance with the size of the preceding car and the like or the position thereof in the width direction of the lane and the like. Further, for example, the degree of the preceding car and the like becoming a noise in the detection of the lane mark varies in accordance with the type of the lane mark, such as a white line, a yellow line, and road studs. Therefore, in the device of the Patent Document 1, it is possible that the lane recognition accuracy is impaired by excessively limiting the processing area, or in contrast, that unnecessary information remains in the processing area.

### SUMMARY OF THE INVENTION

In view of the above circumstances, an object of the present invention is to provide a lane recognition device, a vehicle thereof, a lane recognition method, and a lane recognition program that could improve the recognition accuracy of the lane by appropriately removing the influence of subjects other than the lane mark captured in the image of the road, when recognizing the lane along which the vehicle is traveling by detecting the lane mark from the image of the road.

According to the present invention, there is provided a lane recognition device which recognizes a lane along which a vehicle is traveling by detecting a lane mark on the road defining the lane, from an image of the road acquired via an imaging device mounted on the vehicle, comprising: an object detection unit which detects an object other than the lane mark existing ahead of the vehicle; and a lane mark detection unit which detects the lane mark on the basis of data obtained by removing the area corresponding to the object detected by the object detection unit from data related to the image of the road (a first aspect of the invention).

In the lane recognition device of the first aspect of the invention, the object detection unit detects subjects other than the lane mark such as the preceding car or the pedestrian on the road as the object. Thereafter, the lane mark detection unit detects the lane mark on the basis of the data obtained by removing the area corresponding to the object detected by the object detection unit from the data related to the image of the road (image data, or data obtained by providing filtering process to the image data). Therefore, the lane mark defining the lane along which the vehicle is traveling may be detected with good accuracy, by appropriately removing influence of subjects other than the lane mark captured in the image of the road. Therefore, the recognition accuracy of the lane may be improved.

Further, in the lane recognition device in the first aspect of the invention, it is preferable that the lane mark detection unit executes a removal process which removes the area corresponding to the object detected by the object detection unit to the acquired data of the image of the road, and detects the lane mark by providing a filtering process to the data of the image subjected to the removal process (a second aspect of the invention).

In this case, the lane mark detection unit extracts the edge points by providing differentiation filtering process, for example, to the data of the image subjected to the removal process, and detects the lane mark on the basis of the edge points. By doing so, the situation where data corresponding to subjects other than the lane mark is extracted during the filtering process may be avoided, so that the detection accuracy of the lane mark may be improved.

Further, in the lane recognition device of the first aspect of the invention, it is preferable that the lane mark detection unit executes a removal process which removes the area corresponding to the object detected by the object detection unit to the data obtained by providing filtering process to the acquired image of the road, and detects the lane mark on the basis of the data subjected to the removal process (a third aspect of the invention).

In this case, the lane mark detecting unit extracts the candidates of the lane mark by providing the filtering process to the data of the image, for example, and determines the actual lane mark from the candidates of the lane mark on the basis of the data obtained by removing the area corresponding to the object other than the lane mark. By doing so, the situation where data corresponding to subjects other than the lane mark is determined from the lane mark candidates as the lane mark may be avoided, so that the detection accuracy of the lane mark may be improved.

Moreover, in the lane recognition device of the first aspect of the invention, it is preferable that the lane mark detection unit comprises a lane mark type recognition unit which recognizes the type of the lane mark on the basis of the data obtained by providing the filtering process to the acquired image of the road, and a removal determination unit which determines whether or not to execute the removal process on the basis of the recognition result of the lane mark type recognition unit, and in the case where the removal determination unit determines that the removal process should be executed, the lane mark detection unit executes the removal process which removes the area corresponding to the object detected by the object detection unit to the data obtained by providing filtering process to the acquired image of the road, and detects the lane mark on the basis of the data subjected to the removal process (a fourth aspect of the invention).

That is, when detecting the lane mark from the data obtained by providing filtering process, on the basis of the type of the lane mark, the degree of the object other than the lane mark existing ahead of the vehicle becoming a noise in the data differs with the type of the lane mark. For example, it is conceivable that the lane mark of a stud type such as the road studs in which the data becomes discrete has higher degree of the object other than the lane mark becoming a noise when detecting the lane mark, compared to the case of the linear lane mark such as the white line. Therefore, by recognizing the type of the lane mark, and by executing the removal process only when it is determined that the removal process should be executed on the basis of the recognition result, the detection accuracy of the lane mark may be improved more effectively.

Further, in the lane recognition device of the first aspect of the invention, for example when a distance sensor such as a radar is mounted on the vehicle, it is preferable that the object detection unit detects the object other than the lane mark on the basis of a detection result by the distance sensor mounted on the vehicle (a fifth aspect of the invention).

In this case, the three-dimensional position of the preceding car or the like to the vehicle is detected by the distance sensor, so that the position and the size of the area corresponding to the object other than the lane mark within the image may be specified with good accuracy, and therefore the data of the area may be removed appropriately.

Moreover, in the lane recognition device of the first aspect of the invention, it is preferable that the object detection unit detects the object by providing the filtering process to the acquired image (a sixth aspect of the invention).

In this case, there is no need for other configurations such as the distance sensor for detecting the object, so that the area corresponding to the object other than the lane mark within the image may be specified by a simple configuration, and the data of the area may be removed appropriately.

Further, in the lane recognition device of the sixth aspect of the present invention, it is preferable that the object detection unit provides an optical flow process to the acquired image as the filtering process, calculates a change amount of a relative position of the object to the vehicle within the image, and detects the object whose calculated change amount of the relative position is smaller than a predetermined value as the object other than the lane mark (a seventh aspect of the invention).

In this case, the change amount of the relative position of the specific object within the image may be calculated appropriately by the optical flow process, and the object whose change amount of the relative position is smaller than the predetermined value is detected as subjects other than the lane mark. Here, subjects such as the preceding car moving similarly to the vehicle has a small relative velocity to the vehicle, so that the subjects may be detected with good accuracy as the object by the object detection unit. And, of the subjects existing in the vicinity of the vehicle, subjects such as the preceding car are continuously captured within the image ahead of the vehicle, so that there is a high possibility of the preceding car becoming a noise when detecting the lane mark from the image. Therefore, by removing the area corresponding to the object from the data related to the image, the detection accuracy of the lane mark may be improved with good efficiency.

Moreover, in the lane recognition device of the sixth aspect of the invention, it is preferable that the object detection unit provides an edge extraction process to two images acquired time-continuously via the imaging device as the filtering process, calculates a change amount of a position between the object within the two images, and detects the object whose calculated change amount of the position is smaller than a predetermined value as the object other than the lane mark (an eighth aspect of the invention)

In this case, the object within each of the image is extracted by the edge extraction process, the change amount of the position of the specific object between the two images captured time-continuously may be calculated with ease. Here, subjects such as the preceding car moving similarly to the vehicle has a small relative velocity to the vehicle, and the change amount of the position between the two images captured time-continuously by the imaging means mounted on the vehicle is small, so that the subjects may be detected with good accuracy as the object by the object detection unit. And, of the subjects existing in the vicinity of the vehicle, subjects such as the preceding car are continuously captured in the image ahead of the vehicle, so that there is a high possibility of the preceding car becoming a noise when detecting the lane mark from the image. Therefore, by removing the area corresponding to the object from the data related to the image, the detection accuracy of the lane mark may be improved with good efficiency.

Moreover, in the lane recognition device of the sixth embodiment of the invention, it is preferable that the device includes an object determination unit which determines whether or not the object is the lane mark on the basis of the standard of the lane mark on the road, wherein the object detection unit executes the process which detects the object other than the lane mark by providing the filtering process to the acquired image, and determines, from candidates of the object other than lane mark detected as a result of the process, the candidate determined not as a lane mark by the object determination unit as the object other than the lane mark (a ninth aspect of the invention).

That is, the lane mark on the road is preliminary provided by the standard of the road, so that for example in the case of the white line, the width of the white line, and the length of the white line or the like takes a value of a predetermined range. Therefore, by determining the objects other than the lane mark on the basis of the standard of the road from the candidates obtained by providing the filtering process, the possibility of the erroneous detection during the detection of the objects other than the lane mark may be reduced, so that the detection accuracy of the lane mark may be improved further.

Next, a vehicle of the present invention is a vehicle to which the lane recognition device according to the present invention is mounted (a tenth aspect of the invention). In this case, the vehicle in which the lane recognition accuracy is improved may be realized.

Next, a lane recognition method of the present invention is a method which recognizes a lane along which a vehicle is traveling by detecting a lane mark on the road defining the lane, from an image of the road acquired via an imaging device mounted on the vehicle, comprising the steps of: an object detection step which detects an object other than the lane mark existing ahead of the vehicle; and a lane mark detection step which detects the lane mark on the basis of data obtained by removing the area corresponding to the object detected in the object detection step from data related to the image of the road (an eleventh aspect of the invention).

According to the lane recognition method of the present invention, as explained in relation to the lane recognition device of the present invention, subjects other than the lane mark such as the preceding car and the pedestrian on the road are detected as the object in the object detection step. Thereafter, in the lane mark detection step, the lane mark is detected on the basis of the data obtained by removing the area corresponding to the object detected in the object detection step from the data related to the image of the road. Therefore, the influence of subjects other than the lane mark captured in the image of the road may be removed appropriately, so that the lane mark defining the lane along which the vehicle is traveling may be detected with good accuracy. By doing so, the recognition accuracy of the lane may be improved.

Next, a lane recognition program of the present invention is a program which makes a computer execute the process which recognizes a lane along which a vehicle is traveling by detecting a lane mark on the road defining the lane, from an image of the road acquired via an imaging device mounted on the vehicle, comprising the functions of making the computer execute the process of: an object detection process which detects an object other than the lane mark existing on the road; and a lane mark detection process which detects the lane mark on the basis of data obtained by removing the area corresponding to the object detected in the object detection step from data related to the image of the road (a twelfth aspect of the invention).

According to the lane recognition program of the present invention, it is possible to make the computer execute the process which could provide the effect explained in relation to the lane recognition device of the present invention.

### BRIEF DESCRIPTION OF THE DRAWINGS

FIG. 1 is a functional block diagram of a lane recognition device according to a first embodiment of the present invention.

FIG. 2 is a flowchart indicating a lane recognition process of the lane recognition device according to FIG. 1 and a process on the basis of the result thereof.

FIG. 3 is an illustrative diagram of a processed image in the lane recognition process in FIG. 2.

FIG. 4 is a functional block diagram of a lane recognition device according to a second embodiment of the present invention.

FIG. 5 is a functional block diagram of a lane recognition device according to a third embodiment of the present invention.

FIG. 6 is a flowchart indicating a lane recognition process of the lane recognition device according to FIG. 5 and a process on the basis of the result thereof.

FIG. 7 is an illustrative diagram of a processed image in the lane recognition process in FIG. 6.

FIG. 8 is a functional block diagram of a lane recognition device according to a fourth embodiment of the present invention.

FIG. 9 is a functional block diagram of a lane recognition device according to a fifth embodiment of the present invention.

FIG. 10 is a flowchart indicating a lane recognition process of the lane recognition device according to FIG. 9 and a process on the basis of the result thereof.

FIG. 11 is an illustrative diagram of a processed image in a lane recognition process in FIG. 9.

FIG. 12 is an illustrative diagram of a processed image in a lane recognition process of a lane recognition device according to a sixth embodiment of the present invention.

FIG. 13 is an illustrative diagram of a processed image in a lane recognition process of a lane recognition device according to a seventh embodiment of the present invention.

### DETAILED DESCRIPTION OF THE PREFERRED EMBODIMENTS

### First Embodiment

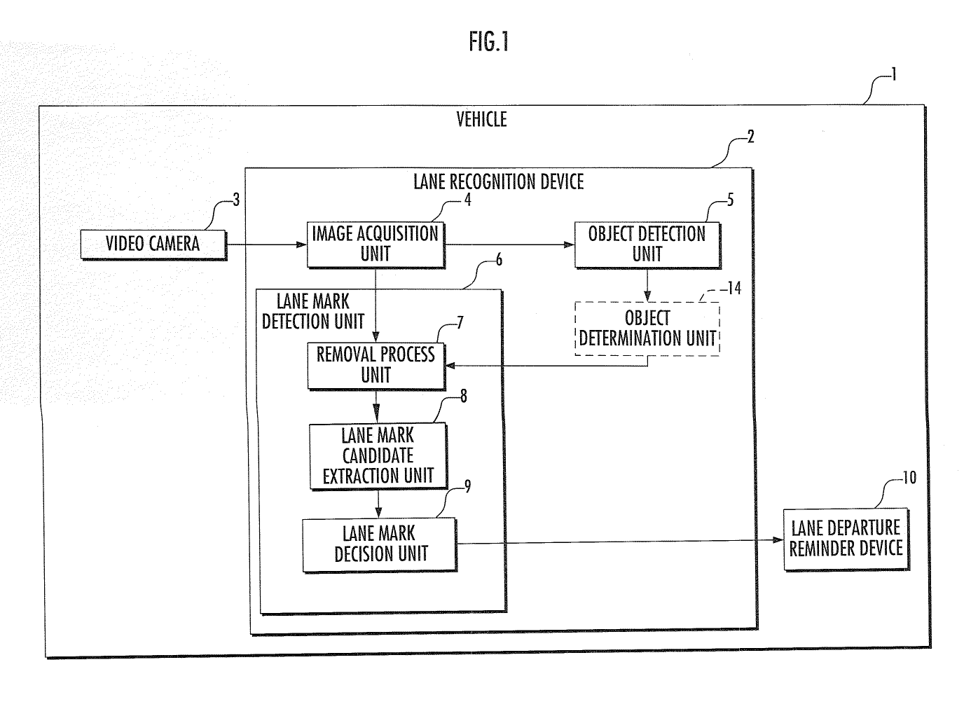

As indicated in FIG. 1, a lane recognition device 2 is mounted on a vehicle 1, and is connected to a video camera 3 which captures an image of the road ahead of the vehicle and a lane departure reminder device 10 which reminds a driver of the vehicle 1 of the possibility of the vehicle 1 departing from the lane on the basis of the data of the lane recognized by the lane recognition device 2.

And the lane recognition device 2 has, as the function thereof, an image acquisition unit 4 which captures the image of the road via the video camera 3, an object detection unit 5 which detects an object other than the lane mark existing ahead of the vehicle on the basis of the acquired image, and a lane mark detection unit 6 which detects the lane mark on the basis of the acquired image and the object detected by the object detection unit 5. Here, the detection objects of the lane mark detection unit 6 are linear lane marks such as a white line and a yellow line, and stud type lane marks discretely provided on the road such as road studs (Botts Dots: Non Retroreflective Raised Pavement Marker, Cat' Eye: Raised Pavement Marker, and the like). Further, an object determination unit 14 indicated by a broken line in FIG. 1 is a configuration provided in a seventh embodiment of the present invention, so that explanation thereof will be omitted in this embodiment.

The lane recognition device 2 is an electronic unit composed of an A/D conversion circuit which converts an input analog signal to a digital signal, an image memory which stores the digitized image signal, a computer (an arithmetic processing circuit including a CPU, a memory, and I/O circuits, or a microcomputer having all of these functions) which has an interface circuit for use in accessing (reading and writing) data stored in the image memory to perform various types of arithmetic processing for the images stored in the image memory, and the like.

The functions of the lane recognition device 2 are realized by executing a program previously implemented in the memory of the computer with the computer. This program includes a lane recognition program of the present invention. The program can be stored in the memory via a recording medium such as a CD-ROM. In addition, the program can be delivered or broadcasted from an external server over a network or a satellite and be stored in the memory after it is received from a communication device mounted on the vehicle 1.

Although not shown, the lane departure reminder device 10 is equipped with a loudspeaker for outputting voice which reminds the driver, and a display device which displays the image acquired via the video camera 3 and information such as the possibility of departing from the lane.

The image acquisition unit 4 acquires a road image composed of pixel data via the video camera 3 (the imaging device of the present invention such as a CCD camera) which is attached to the front of the vehicle 1 to capture the image of the road ahead of the vehicle 1. The output of the video camera 3 (a video signal of color image) is loaded to the image acquisition unit 4 at a predetermined process cycle. The image acquisition unit 4 provides A/D conversion the input video signal (an analog signal) of each pixel of the image captured by the video camera 3, and stores the digital data obtained by the A/D conversion to an image memory not shown.

The object detection unit 5 provides an optical flow process to the image of the road acquired by the image acquisition unit 4, and calculates a change amount of the relative position between the object within the image and the vehicle 1. Thereafter, the object detection unit 5 detects the object whose calculated change amount of the relative position is smaller than a predetermined value as the object other than lane mark, such as a preceding car.

The lane mark detection unit 6 is equipped with a removal process unit 7 which executes a removal process of removing from the data of the image acquired by the image acquisition unit 4 the area corresponding to the object detected by the object detection unit 5, a lane mark candidate extraction unit 8 which extracts and selects a lane mark candidate by providing a filtering process to data subjected to the removal process, and a lane mark decision unit 9 which decides the data of the lane mark defining the lane from the selected lane mark candidates.

The removal process unit 7 specifies the area corresponding to the object detected by the object detection unit 5 within the data of the image acquired by the image acquisition unit 4. Thereafter, the removal process unit 7 removes the corresponding area from the data of the image.

The lane mark candidate extraction unit 8 provides the filtering process to data subjected to the removal process by the removal process unit 7, and extracts the lane mark candidate that is the data of the candidate of the lane mark defining the lane along which the vehicle is traveling. To be more specific, the lane mark candidate extraction unit 8 executes an edge extraction process which extracts edge points by using a differentiation filter to the data subjected to the removal process, a straight line search process which searches the extracted edge points for a straight line component, and a lane mark candidate selection process which selects the straight line component satisfying a predetermined condition as the lane mark candidate.

The lane mark decision unit 9 decides the straight line component which corresponds to the lane mark of the road along which the vehicle 1 is traveling from the lane mark candidates selected by the lane mark candidate extraction unit 8, and outputs the same as the data of the recognized lane.

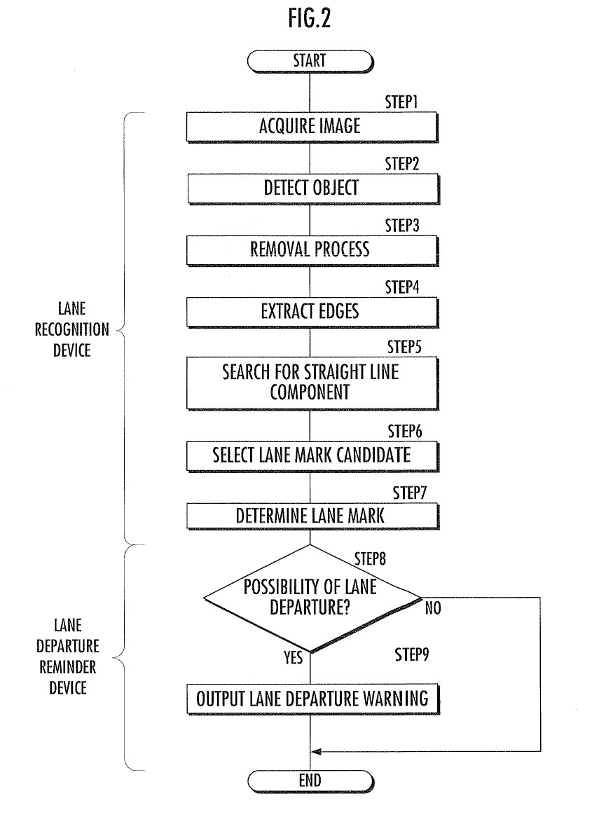

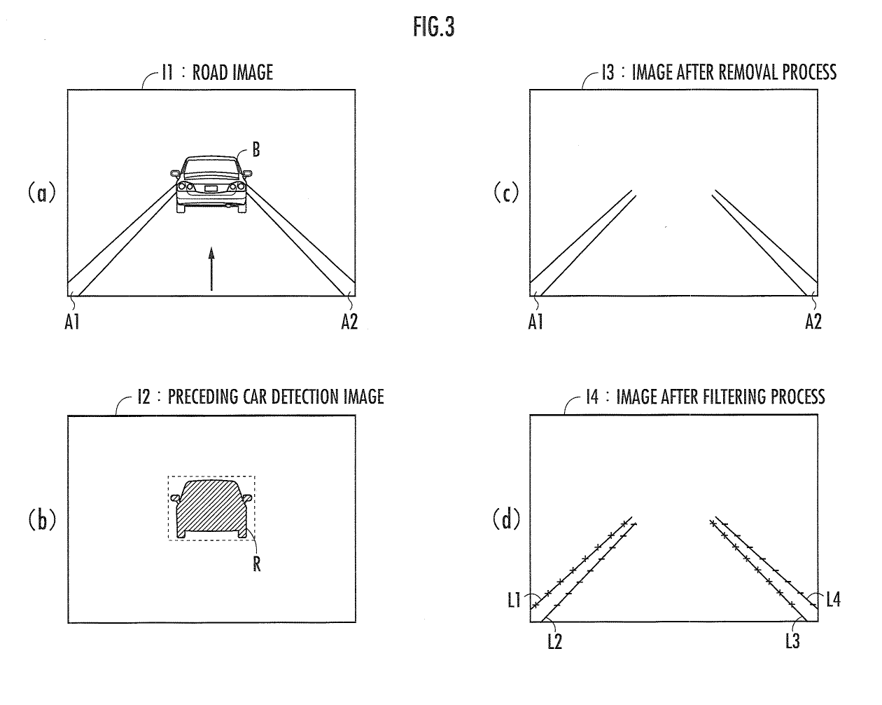

Next, the operation of the lane recognition device 2 (the lane recognition process) of the present embodiment and the operation of the lane departure reminder device 10 on the basis of the recognition result will be explained according to the flowchart indicated in FIG. 2. In the following, as indicated in FIG. 3(a), a case in which the left side of the lane of the road along which the vehicle 1 is traveling is defined by a line type lane mark A1, and the right side of the lane is defined by a line type lane mark A2, will be used as an example for the explanation. Further, in the case indicated in FIG. 3(a), the vehicle 1 is traveling in the direction of the arrow, and a preceding car B exists ahead of the vehicle 1. Moreover, the lane marks A1 and A2 are white lines, and are the detection object of the lane recognition device 2.

As indicated in FIG. 2, first in STEP 1, the image acquisition unit 4 inputs the video signal output from the video camera 3, and acquires a road image I1 composed of pixel data. Here, the lane recognition device 2 of the vehicle 1 executes the lane recognition process in STEP 1 through STEP 7 in FIG. 2 in every predetermined control cycle.

Next, in STEP 2, the object detection unit 5 executes a process for detecting objects other than the lane mark from the acquired image. To be more specific, the object detection unit 5 first obtains an optical flow of a predetermined region of each time-continuous image. The optical flow may be obtained by a known technique such as a block matching technique on a local region. Next, the object detection unit 5 detects the group of continuous pixels within the local region having the optical flow smaller than a predetermined magnitude within the image as the object. By doing so, a pixel region R of an area corresponding to the preceding car B in the image I1 is identified, as is indicated in an image I2 in FIG. 3(b).

As a technique for detecting the objects such as the preceding car from the image, techniques other than the technique based on the optical flow such as, for example, an inter-frame difference technique which calculates a difference between time-continuous image data and detect the object based on the calculated data, or a technique of detecting as the feature the shade below the vehicle and the like, may be used.

Next, in STEP 3, the removal process unit 7 removes the data of pixels equivalent to the group of pixels corresponding to the detected object from the image. By doing so, the data of pixels of the area corresponding to the preceding car B in the image I1 is removed as is indicated in an image I3 in FIG. 3(c).

Next, in STEP 4, the lane mark candidate extraction unit 8 provides an edge extraction process to the image subjected to the extraction process by the removal process unit 7 and extracts edge points (an edge extraction process). The lane mark candidate extraction unit 8 extracts edge points by providing differentiation filter to the image I3 subjected to removal process. In this process, the lane mark candidate extraction unit 8 extracts an edge point where the luminance level of the image I1 changes from high luminance (light) to low luminance (dark) as a negative edge point and extracts an edge point where the luminance level changes from low luminance (dark) to high luminance (light) as a positive edge point with the search direction oriented to the right in the image I3. The luminance value of each of the pixels of the image I1 may be calculated, for example, from the R value, the G value, and the B value of each of the pixels of the acquired color image I0.

This enables the edge points in the image I3 to be extracted as indicated in an image I4 in FIG. 3(d). In FIG. 3(d), the positive edge point is indicated by a plus sign “+” and the negative edge point is indicated by a minus sign “−.” Referring to FIG. 3(d), the left edge portions of the white lines A1 and A2 are extracted as positive edge points and the right edge portions of the white lines A1 and A2 are extracted as negative edge points. As such, the data of the area in which the preceding car B is captured is removed in the image I2. Therefore, upon executing the edge extraction process, the edge points indicating the preceding car B is not extracted, and only the edge points indicating the lane marks A1 and A2 are extracted.

Next, in STEP 5, the lane mark candidate extraction unit 8 executes the straight line search process for searching the edge points extracted by the edge extraction process for a straight line component which is point sequence data of a plurality of linearly located edge points. As a specific approach for searching for a straight line component by extracting edge points from an image, it is possible to use, for example, a technique as described in Japanese Patent No. 3429167 filed by the present applicant.

To be more specific, first, the lane mark candidate extraction unit 8 transforms the extracted positive edge points by Hough transform and negative edge points to search for a straight line component L in the Hough space. In this situation, the straight line component corresponding to the white line generally points to an infinite point on the image and therefore the lane mark candidate extraction unit 8 searches for a point sequence of a plurality of edge points located in straight lines passing through the infinite point. Subsequently, the lane mark candidate extraction unit 8 performs projective transformation from the Hough space to the image space for the data on the straight line component searched for and further performs projective transformation from the image space to the real space (the coordinate space fixed to the vehicle).

This allows n numbers of straight line components L1, . . . , Ln to be found. The straight line components L1 to Ln are each made of coordinate data of a point sequence indicated by a plurality of edge points. For example, four straight line components L1 to L4 are found from edge points shown in an image I4 of FIG. 3(d).

Next, in STEP 6, the lane mark candidate extraction unit 8 executes a lane mark candidate selection process which selects from the straight line component searched for by the straight line search process the straight line component satisfying a predetermined condition as the candidate (a candidate of lane mark) of the straight line component corresponding to the lane mark of the road. As the predetermined condition, the straight line component having an evaluation value larger than a predetermined threshold, in which the evaluation value indicates the degree of closeness of each straight line component to the lane mark of the road, may be cited as an example. By doing so, four straight line components L1 through L4 are selected as candidates of lane mark, as is illustrated in the image I4 in FIG. 3(d).

Next in STEP 7, the lane mark decision unit 9 detects the white lines A1 and A2, which define the lane along which the vehicle 1 travels, from the selected lane mark candidates. First, the lane mark decision unit 9 decides the straight line component L3, which is located in the right side area of the image I4, found from the positive edge points, and closest to the center of the lane within the area, as a straight line component corresponding to the edge portion of the white line A2 in the inside of the lane among the selected lane mark candidates. Similarly, the lane mark decision unit 9 decides the straight line component L2, which is located in the left side area of the image I4, found from the negative edge points, and closest to the center of the lane within the area, as a straight line component corresponding to the edge portion of the white line A1 in the inside of the lane.

Subsequently, the lane mark decision unit 9 combines the straight line components L2 and L3 corresponding to the edge portions of the white lines A1 and A2 in the inside of the lane with the straight line components L corresponding to the edge portions of the white lines A1 and A2 in the outside of the lane, respectively. In the right side area of the image I4, the lane mark decision unit 9 combines the line component L4, which is found from the negative edge points located in the right side of the straight line component L3 and whose distance between each of the straight line component seems to be appropriate as a white line, with the line L3. In the left side area of the image I4, the lane mark decision unit 9 combines the straight line component L1, which is found from the positive edge points located in the left side of the straight line component L2 and whose distance between each of the straight line component seems to be appropriate as a white line, with the straight line component L2. Thereby, as illustrated in the image I4 of FIG. 3(d), the lane mark decision unit 9 decides the white line A1 as an area between the straight line components L1 and L2 and the white line A2 as an area between the straight line components L3 and L4. Thereafter, data of the straight line components L1 through L4 are output as the data of the recognized lane.

Next in STEP 8, the lane departure reminder device 10 determines whether or not there is a possibility of the vehicle 1 departing from the lane, based on the lane of the data recognized as explained above by the lane recognition device 2. To be more specific, the lane departure reminder device 10 calculates the position of the subject vehicle, the curvature of the road, the target route and the like, on the basis of the data of the lane output from the lane mark decision unit 9, the traveling speed of the vehicle 1 and the like, and determines whether or not there is a possibility of the vehicle 1 departing from the lane along which the vehicle is traveling.

If the determination result in STEP 8 is YES (there is a possibility of the vehicle departing from the lane), then the process proceeds to STEP 9, and the lane departure reminder device 10 performs a reminding process using voice and display to the driver of the vehicle 1, and then the process returns to STEP 1. In the reminding process, for example, the image acquired via the video camera is displayed on the display device, with the lane portion within the image being emphasized. Further, the possibility of departing from the lane is announced to the driver by voice via the loudspeaker. Here, the reminding to the driver may be performed only by either one of the loudspeaker and the display device.

On the other hand, if the determination result in STEP 8 is NO (there is no possibility of the vehicle departing from the lane), then the process returns to STEP 1 without performing reminding process to the driver of the vehicle 1.

With the process mentioned above, it is possible to detect the white lines A1 and A2 from the image I1 of the road with good accuracy, by appropriately removing information related to the object other than the lane mark, such as a preceding car, so that the recognition accuracy of the lane may be improved.

### Second Embodiment

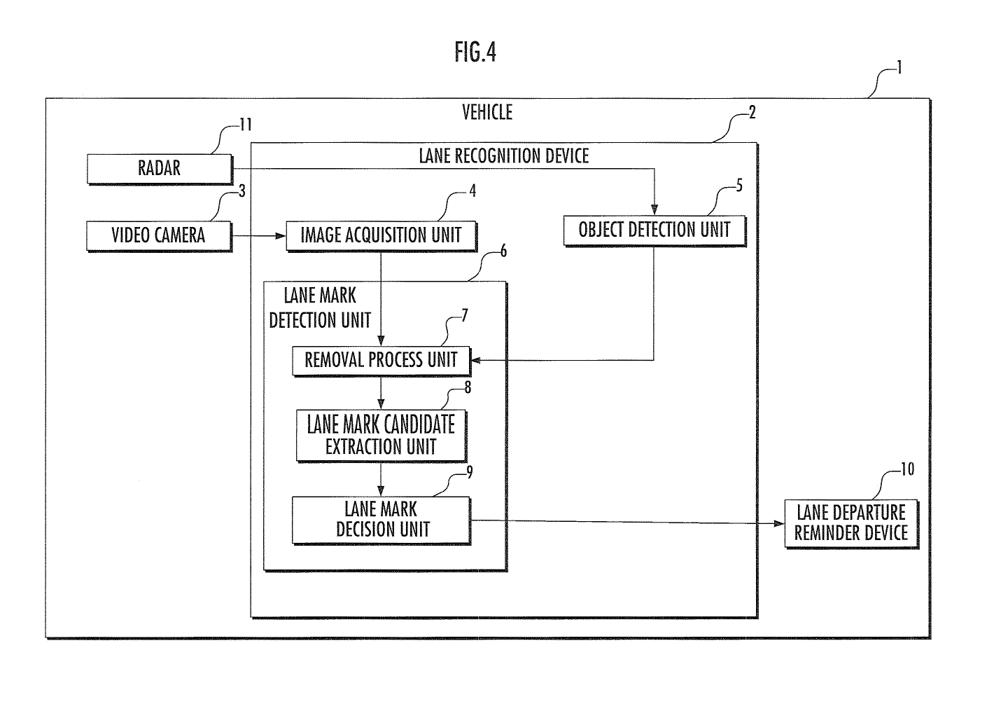

Subsequently, a second embodiment of the present invention will now be explained with reference to FIG. 4. This embodiment is equivalent to the first embodiment except that the vehicle 1 is equipped with a radar 11. In the following description, like elements to those of the first embodiment are denoted by like reference numerals and the description thereof is omitted.

In the present embodiment, a radar (a distance sensor) 11 which detects a relative position of subjects existing ahead of the vehicle 1 to the vehicle 1 is mounted on the vehicle 1. Then, the object detection unit 5 detects the objects other than the lane mark, such as the preceding car, ahead of the vehicle, on the basis of the detection result of the radar 11. Further, the object detection unit 5 specifies the region corresponding to the object in the image acquired by the image acquisition unit 4, on the basis of the information on the detected object (the position, the distance to the vehicle 1). Other parts which are not described in the above are the same as in the first embodiment.

Next, the operation of the lane recognition device (the lane recognition process) according to the present embodiment will now be described below. The lane recognition process in the present embodiment differs from the first embodiment only in the process of detecting the object (STEP 2 in FIG. 2). Since the flowchart of the lane recognition process in this embodiment is the same as in FIG. 2, the following description will be given with reference to the flowchart shown in FIG. 2.

In STEP 2 of the present embodiment, first, the object detection unit 5 reads the relative position of subjects ahead of the vehicle detected by the radar 11 to the vehicle 1. Then, the object detection unit 5 detects the object other than the lane mark from subjects ahead of the vehicle 1.

Subsequently, the object detection unit 5 provides projective transformation to the coordinates of the object detected by the radar from the real space (the coordinate space fixed to the vehicle) to the image space. The projective transformation is performed based on so-called camera parameters such as a focal length or a mounting position of a camera. The coordinate space fixed to the vehicle means a two-dimensional coordinate system placed in the road plane with the subject vehicle 1 as an origin.

Thereafter, the object detection unit 5 specifies the position and the size of the region of pixels corresponding to the object in the image. By doing so, the region R in FIG. 3(b) is specified. The operations other than those described in the above are the same as in the first embodiment.

With the above process, it is possible to detect the white lines A1 and A2 from the image I1 of the road with good accuracy by appropriately removing information related to the object other than the lane mark, such as a preceding car, so that the recognition accuracy of the lane may be improved, similarly to the first embodiment.

### Third Embodiment

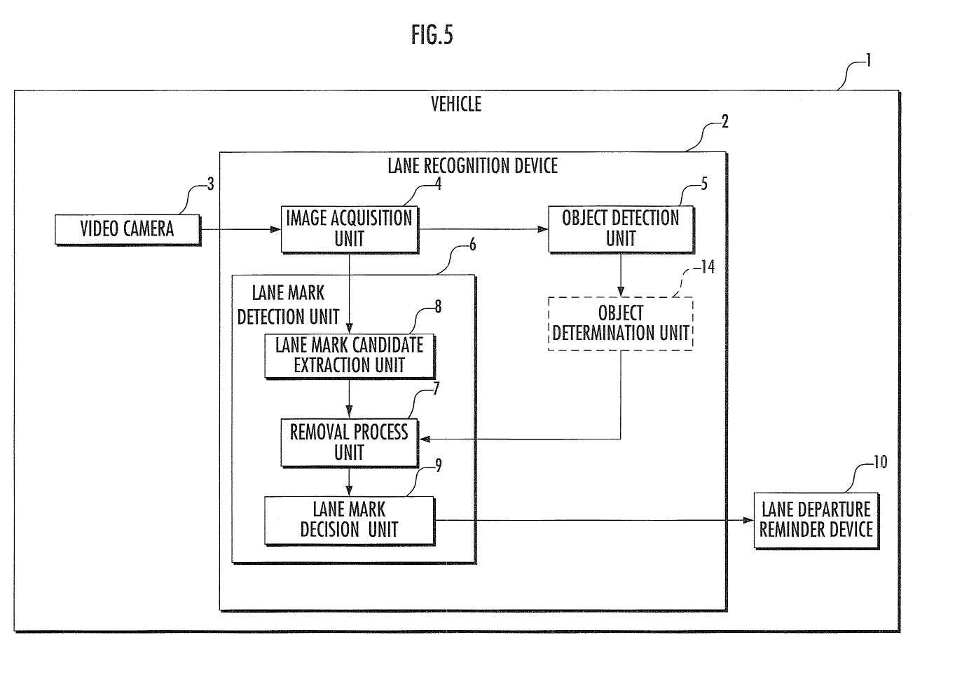

Subsequently, a third embodiment of the present invention will now be described with reference to FIG. 5.

This embodiment is equivalent to the first embodiment except that the area with reference to the timing of the removal process in the lane mark detection unit 6 is different from that in the first embodiment. In the following description, like elements to those of the first embodiment are denoted by like reference numerals and the description thereof is omitted.

In the present embodiment, the lane mark candidate extraction unit 8 of the lane mark detection unit 6 provides a filtering process to the image of the road acquired via the video camera 3. Thereafter, the removal process unit 7 executes the removal process to the data obtained by providing the filtering process. Then, the lane mark decision unit 9 decides the lane mark which defines the lane along which the vehicle 1 is traveling, on the basis of the data subjected to removal process. The operations other than those described in the above are the same as in the first embodiment.

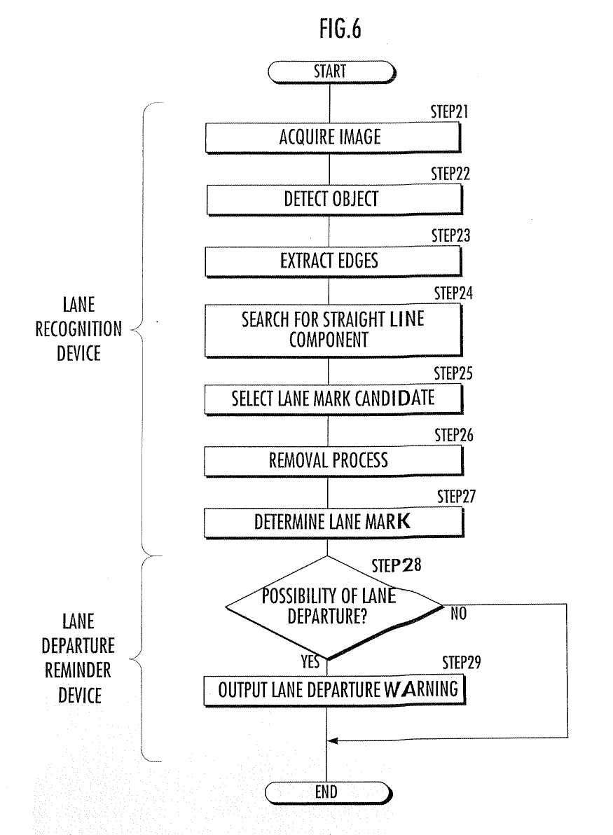

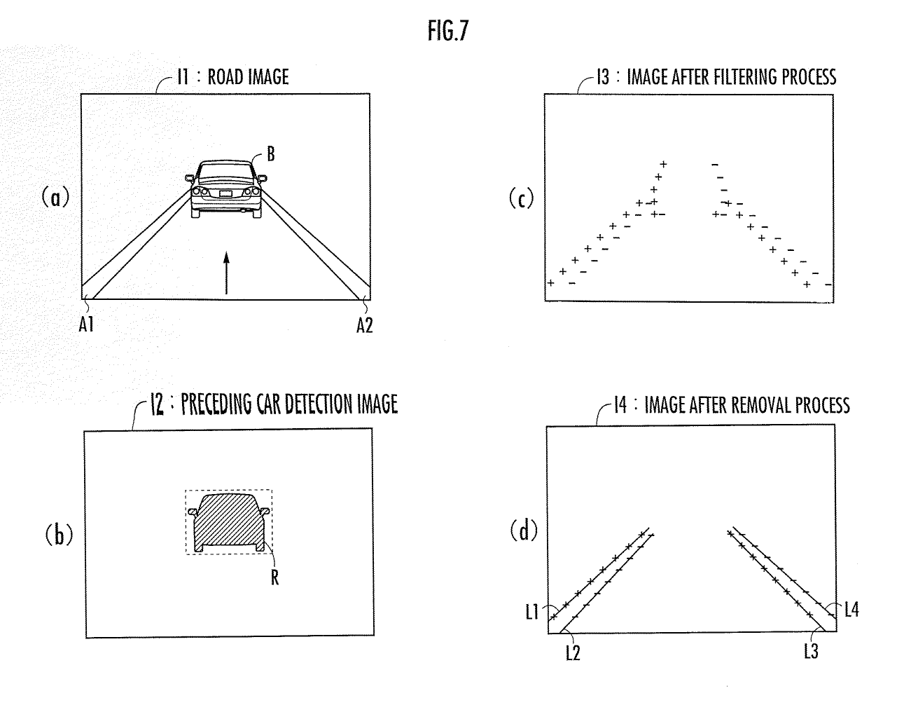

Next, the operation of the lane recognition device 2 (the lane recognition process) according to the present embodiment will now be described below with reference to the flowchart shown in FIG. 6. In the following, as indicated in FIG. 7(a), a case in which the left side of the lane of the road along which the vehicle 1 is traveling is defined by a line type lane mark A1, and the right side of the lane is defined by a line type lane mark A2, will be used as an example for the explanation. Further, in the case indicated in FIG. 7(a), the vehicle 1 is traveling in the direction of the arrow, and a preceding car B exists ahead of the vehicle 1.

First, in STEP 21, similarly to STEP 1 in FIG. 2, the image acquisition unit 4 acquires an image I1 of the road from the video camera 3. Thereafter, in STEP 22, similarly to STEP 2 in FIG. 2, the object detection unit 5 provides the filtering process to the acquired image and detects the object other than the lane mark such as the preceding car. By doing so, the pixel region R of the area which corresponds to the preceding car B in the image I1 is specified as shown in an image I2 in FIG. 7(b). Next, in STEP 23, the lane mark candidate extraction unit 8 performs the edge extraction process which extracts edge points by providing differentiation filter process to the image I1 obtained in STEP 21. By doing so, the edge points are extracted as indicated in an image I3 of FIG. 7(c). Next, in STEP 24, the lane mark candidate extraction unit 8 provides the straight line search process to the data of the extracted edge points. Next, in STEP 25, the lane mark candidate extraction unit 8 executes the lane mark candidate selection process which selects from the straight line components searched for by the straight line search process the line component satisfying the predetermined condition as the candidate of the straight line component corresponding to the lane mark of the road (the candidate of lane mark). Here, the details of the process in STEP 23 through STEP 25 are the same as STEP 4 through STEP 6 in FIG. 2.

Subsequently, in STEP 26, the removal process unit 7 executes the removal process to the data of the obtained straight line components Li (i=1, n). First, the removal process unit 7 determines whether or not the straight line component Li is included in the region R corresponding to the object detected by the object detection unit 5 in the image. If the straight line component Li is not included in the range R as a result of the determination, the removal process unit 7 excludes the straight line component Li from the lane mark candidate. On the other hand, if the straight line component Li is included in the range R as a result of the determination, the removal process unit 7 includes the straight line component Li in the lane mark candidate. To be more specific, whether or not the straight line component Li is included in the range R is determined by whether or not a predetermined ratio or more of the edge points constituting the straight line component Li is included in the region R, for example. By doing so, four straight line components L1 through L4 are selected as the lane mark candidates, as is illustrated in an image I4 in FIG. 7(d). As explained above, the straight line components corresponding to subjects other than the lane mark captured in the image may be excluded from the lane mark candidate. As a result, the lane mark may be detected with good accuracy.

Next, in STEP 27, the lane mark decision unit 9 executes the process of deciding the lane mark corresponding to the lane along which the vehicle 1 is traveling to the data subjected to the removal process. Then, the possibility of the departure from the lane is determined in STEP 28, and then the reminding to the driver is performed in STEP 29. The process in STEP 27 through STEP 29 is the same as that in STEP 7 through STEP 9 in FIG. 2.

With the above process, it is possible to detect the white lines A1 and A2 from the image I1 of the road with good accuracy, by appropriately removing information related to the object other than the lane mark, such as a preceding car, so that the recognition accuracy of the lane may be improved, similarly to the first embodiment.

### Fourth Embodiment

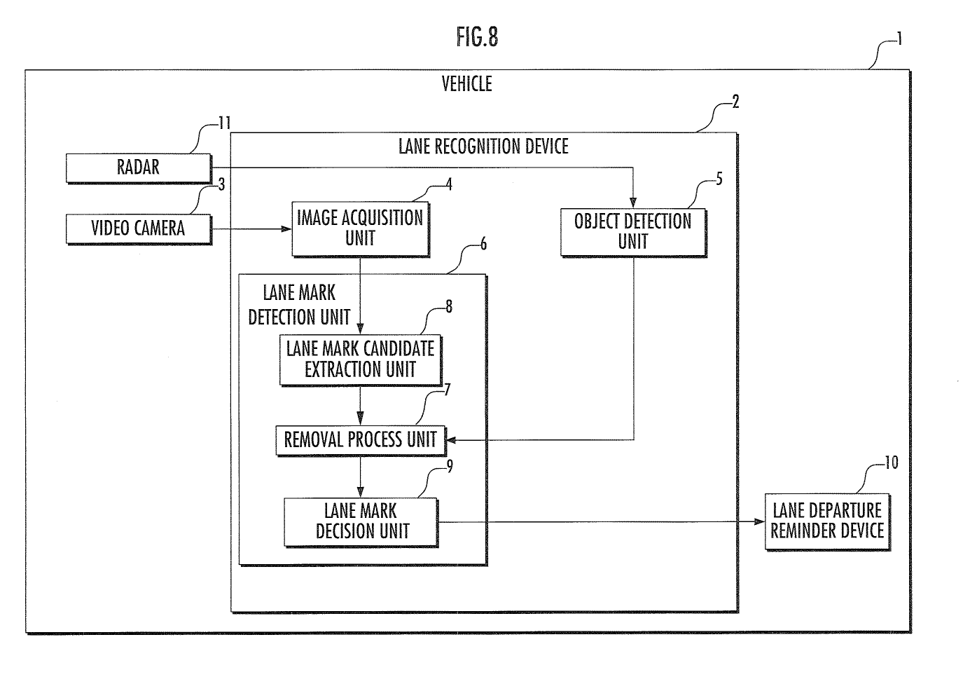

Subsequently, a fourth embodiment of the present invention will now be described with reference FIG. 8. This embodiment is equivalent to the third embodiment except that the vehicle 1 is equipped with the radar 11. In the following description, like elements to those of the third embodiment are denoted by like reference numerals and the description thereof is omitted.

In the present embodiment, as with the second embodiment, the radar (the distance sensor) 11 which detects a relative position of subjects existing ahead of the vehicle 1 to the vehicle 1 is mounted on the vehicle 1. Then, the object detection unit 5 detects the objects other than the lane mark, such as the preceding car, ahead of the vehicle, on the basis of the detection result of the radar 11. Further, the object detection unit 5 specifies the region corresponding to the object in the image acquired by the image acquisition unit 4, on the basis of the information on the detected object (the position, the distance to the vehicle 1). Other parts which are not described in the above are the same as in the third embodiment.

Next, the operation of the lane recognition device 2 (the lane recognition process) according to the present embodiment will now be described below. The lane recognition process in this embodiment differs from the third embodiment only in the process of detecting the object (STEP 2 in FIG. 6). Since the flowchart of the lane recognition process in this embodiment is the same as in FIG. 6, the following description will be given with reference to the flowchart shown in FIG. 6.

In STEP 2 of the present embodiment, as with the second embodiment, the object detection unit 5 reads the relative position of subjects ahead of the vehicle detected by the radar 10 to the vehicle 1. Then, the object detection unit 5 detects the object other than the lane mark from subjects ahead of the vehicle 1. Subsequently, the object detection unit 5 provides projective transformation to the coordinates of the object detected by the radar from the real space (the coordinate space fixed to the vehicle) to the image space. Thereafter, the object detection unit 5 specifies the position and the size of the region of pixels corresponding to the object in the image. The operations other than those described in the above are the same as in the third embodiment.

With the above process, it is possible to detect the white lines A1 and A2 from the image I1 of the road with good accuracy, by appropriately removing information related to the object other than the lane mark, such as a preceding car, so that the recognition accuracy of the lane may be improved, similarly to the third embodiment.

### Fifth Embodiment

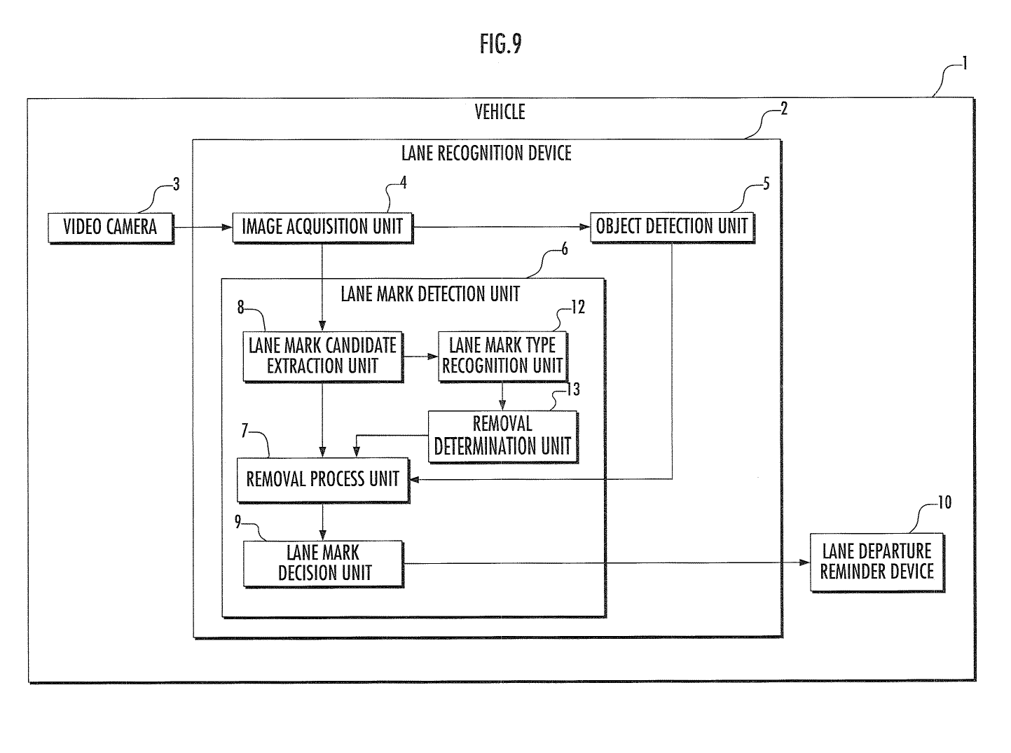

Subsequently, a fifth embodiment of the present invention will now be described with reference FIG. 9. This embodiment is equivalent to the third embodiment except for the area corresponding to the condition in which the lane mark detection unit 6 executes the removal process. In the following description, like elements to those of the third embodiment are denoted by like reference numerals and the description thereof is omitted.

The lane mark detection unit 6 of the present embodiment is equipped with a lane mark type recognition unit 12 which recognizes the type of the lane mark on the basis of the data of the lane mark candidate extracted by the lane mark candidate extraction unit 8, and a removal determination unit 13 which determines whether or not to perform the removal process on the basis of the recognized type of the lane mark. When it is determined by the removal determination unit 13 that the removal process should be carried out, the removal process unit 7 executes the removal process, and the lane mark decision unit 9 decides the lane mark from the data subjected to the removal process. On the other hand, if it is determined by the removal determination unit 13 that the removal process should not be carried out, the removal process unit 7 does not execute the removal process, and the lane mark decision unit 9 decides the lane mark from all of the lane mark candidates extracted by the lane mark candidate extraction unit 8. The operations other than those described in the above are the same as in the third embodiment.

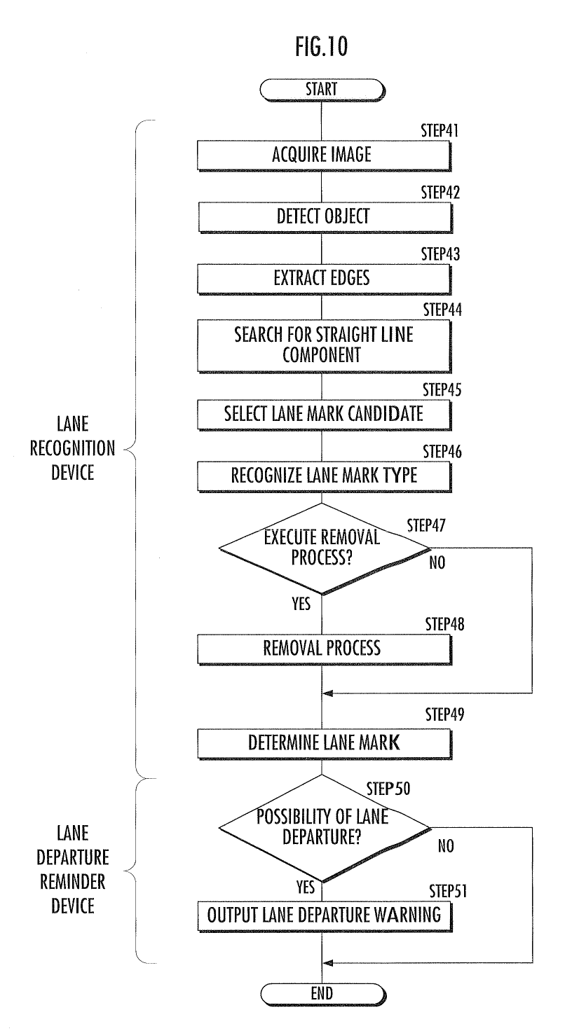

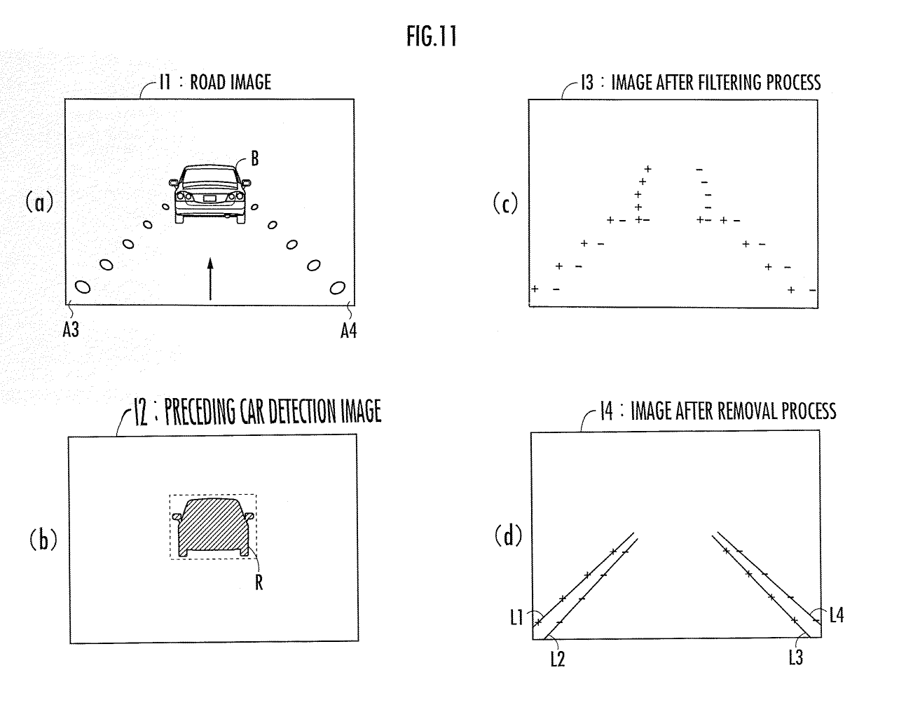

Next, the operation of the lane recognition device (the lane recognition process) of the present invention will be explained according to the flowchart indicated in FIG. 10. In the following, as indicated in FIG. 11(a), a case in which the left side of the lane of the road along which the vehicle 1 is traveling is defined by a plurality of road studs A3, and the right side of the lane is defined by a plurality of road studs A4, will be used as an example for the explanation. Further, in the case indicated in FIG. 11(a), the vehicle 1 is traveling in the direction of the arrow, and a preceding car B exists ahead of the vehicle 1.

First, in STEP 41, as with the STEP 21 in FIG. 6, the image acquisition unit 4 obtains an image I1 of the road from the video camera 3. Thereafter, in STEP 42, as with the STEP 22 in FIG. 6, the object detection unit 5 provides the filtering process to the obtained image, and detects the object other than the lane mark, such as the preceding car. By doing so, the pixel region R of the area which corresponds to the preceding car B in the image I1 is specified as indicated in an image I2 in FIG. 11(b).

Next, in STEP 43, the lane mark candidate extraction unit 8 performs the edge extraction process which extracts edge points by providing differentiation filter process to the image I1 obtained in STEP 41. By doing so, the edge points are extracted as indicated in an image I3 of FIG. 11(c). Next, in STEP 44, the lane mark candidate extraction unit 8 provides the straight line search process to the data of the extracted edge points. Next, in STEP 45, the lane mark candidate extraction unit 8 performs the lane mark candidate selection process which selects from the straight line components searched for by the straight line search process the straight line component satisfying the predetermined condition as the candidate of the straight line component (the candidate of lane mark) corresponding to the lane mark of the road. Here, the details of the process in STEP 43 through STEP 45 are the same as that in STEP 23 through STEP 25 in FIG. 6.

Subsequently, in STEP 46, the lane mark type recognition unit 12 recognizes the type of the selected lane mark candidates. To be more specific, the lane mark type recognition unit 12 recognizes the type of the lane mark on the basis of the characteristics grasped from the image, such as the cycle, the shape, the color, and the length, for example. As such, in an image I3 illustrated in FIG. 10(c), the type of the lane mark is recognized as “road studs.”

Subsequently, in STEP 47, the removal determination unit 13 determines whether or not to execute the removal process, in accordance with the recognized type of the lane mark candidate. For example, when the type of the lane mark candidate is a road stud, it is determined that the removal process should be executed. By doing so, the removal process is executed in the case where the degree of subjects other than the lane mark becoming a noise in the process is high and that there is a higher necessity for removal. In the image I3 illustrated in FIG. 10(c), it is determined that the removal process should be executed.

If the determination result in STEP 47 is YES, the process proceeds to STEP 48, and the removal process unit 7 executes the removal process to the data of the obtained straight line components Li (i=1, n). The details of the process are the same as those for STEP 26 in FIG. 6. By doing so, four straight line components L1 through L4 are selected as the lane mark candidates, as is illustrated in an image I4 in FIG. 11(d). On the other hand, if the determination result in STEP 47 is YES, the process proceeds to STEP 49.

Subsequently, in STEP 49, the lane mark decision unit 9 performs the process of deciding the lane mark corresponding to the lane along which the vehicle 1 is traveling from the lane mark candidates. Then, the possibility of the departure from the lane is determined in STEP 50, and then the reminding to the driver is performed in STEP 51. The process in STEP 49 through STEP 51 is the same as that in STEP 27 through STEP 29 in FIG. 6.

With the above process, it is possible to detect the road studs A3 and A4 from the image I1 of the road with good accuracy, by appropriately removing information related to the object other than the lane mark, such as a preceding car, so that the recognition accuracy of the lane may be improved, similarly to the third embodiment.

In the present embodiment, the object detection unit 5 is configured to detect the object from the image. However, as another embodiment, similarly to the fourth embodiment, the vehicle 1 may be mounted with the radar 11, and the object detection unit 5 may be configured to detect the object on the basis of the detection result of the radar 11.

### Sixth Embodiment

Subsequently, a sixth embodiment of the present invention will now be described. The present embodiment is equivalent to the first embodiment except that the object detection unit 5 provides the edge extraction process as the filtering process. Since the functional block diagram of the lane recognition device in the present embodiment is the same as in FIG. 1, the following description will be given with reference to FIG. 1, and like elements to those of the first embodiment are denoted by like reference numerals and the description thereof is omitted.

In the present embodiment, the object detection unit 5 provides the edge extraction process to two images captured time-continuously via a camera and obtained through the image acquisition unit 4, and calculates a change amount of the position between the object within the two images. Thereafter, the object detection unit 5 detects the object whose calculated change amount of the position is smaller than a predetermined value as the object other than the lane mark. The operations other than those described in the above are the same as in the first embodiment.

Next, the operation of the lane recognition device 2 (the lane recognition process) according to the present embodiment will now be described below. The lane recognition process in the present embodiment differs from the first embodiment only in the process of detecting the object (STEP 2 in FIG. 2). Since the flowchart of the lane recognition process in this embodiment is the same as in FIG. 2, the following description will be given with reference to the flowchart shown in FIG. 2. Further, the case where the lane mark A1 and A2 are white broken lines is taken as the example for explanation.

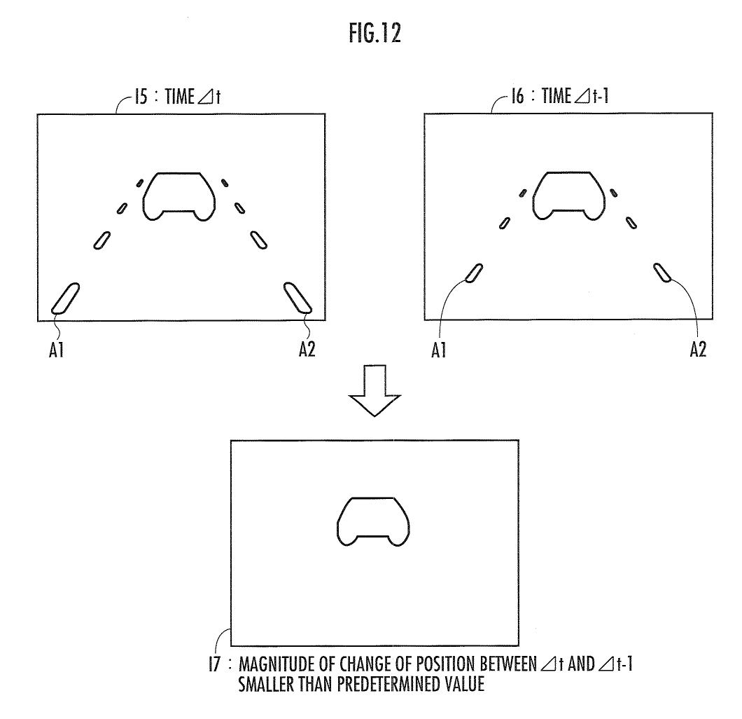

In the present embodiment, in STEP 2, the object detection unit 5 first provides the edge extraction process to the two images captured time-continuously. In FIG. 12, an image I5 obtained by providing the edge extraction process to an image captured at time Δt, and an image I6 obtained by providing the edge extraction process to an image captured at time Δt−1, are illustrated. In the images I5 and I6, the profile line obtained from the edge points by the edge extraction process is indicated in black. Here, the region encircled by this profile line corresponds to the object. Next, the object detection unit 5 compares the image I5 and the image I6, and calculates the change amount of the position between the object in the two images. Thereafter, the object detection unit 5 detects the object whose change amount of the position is smaller than a predetermined value as the object other than the lane mark. The profile line corresponding to the object whose change amount of position is smaller than the predetermined value is illustrated in an image I7 in FIG. 12. As could be seen from above, the objects other than the lane mark such as the preceding car may be detected with ease by a simple edge extraction process. By doing so, the pixel region R of the area corresponding to the preceding car B in the image I1 is specified, as is indicated in the image I2 in FIG. 3(b). The operations other than those described in the above are the same as in the first embodiment.

With the above process, it is possible to detect the white lines A1 and A2 from the image I1 of the road with good accuracy, by appropriately removing information related to the object other than the lane mark, such as a preceding car, so that the recognition accuracy of the lane may be improved, similarly to the first embodiment.

The present embodiment is an embodiment in which the edge extraction process is provided as the filtering process in the first embodiment. As another embodiment, it may be an embodiment in which the edge extraction process is provided as the filtering process in the third embodiment or in the fifth embodiment.

### Seventh Embodiment

Subsequently, a seventh embodiment of the present invention will now be described. The present embodiment is equivalent to the sixth embodiment except that the lane recognition device 2 is equipped with the object determination unit 14. Since the functional block diagram of the lane recognition device in the present embodiment is the same as in FIG. 1, the following description will be given with reference to FIG. 1, and like elements to those of the sixth embodiment are denoted by like reference numerals and the description thereof is omitted.

The object determination unit 14 determines whether or not the object is the lane mark, on the basis of the standard of the lane mark on the road. In the standard of the lane mark, for example in the case of the white line, the width of the white line, the length of the white line, the blank zone between the white line and the white line (the interval between the white line and the white line in the traveling direction of the vehicle in the case where the white line is a broken line), the width of the lane (the interval between the white line and the white line in the width direction of the vehicle), and the like are preliminary determined to be a value within a predetermined range.

Thereafter, in the present embodiment, the object detection unit 5 provides the edge extraction process to the two images captured time-continuously via the camera and acquired by the image acquisition unit 4, and calculates the change amount of the position between the object within the two images. Thereafter, the object detection unit 5 detects the object whose calculated change amount of the position is smaller than a predetermined value as a candidate of the object other than the lane mark. Next, the object determination unit 14 determines whether or not the candidate detected by the object detection unit 5 is the lane mark or not on the basis of the standard of the lane mark. Subsequently, the object detection unit 5 detects the candidate which is determined by the object portion determination unit 14 as not being the lane mark as the object other than the lane mark. The operations other than those described in the above are the same as in the sixth embodiment.

Next, the operation of the lane recognition device (the lane recognition process) in the present embodiment will now be explained. The lane recognition process in the present embodiment differs from the sixth embodiment only in the process of detecting the object (STEP 2 in FIG. 2). Since the flowchart of the lane recognition process in the present embodiment is the same as in FIG. 2, the following description will be given with reference to the flowchart shown in FIG. 2. Further, the case where the lane mark A1 and A2 are white solid line is taken as the example for explanation.

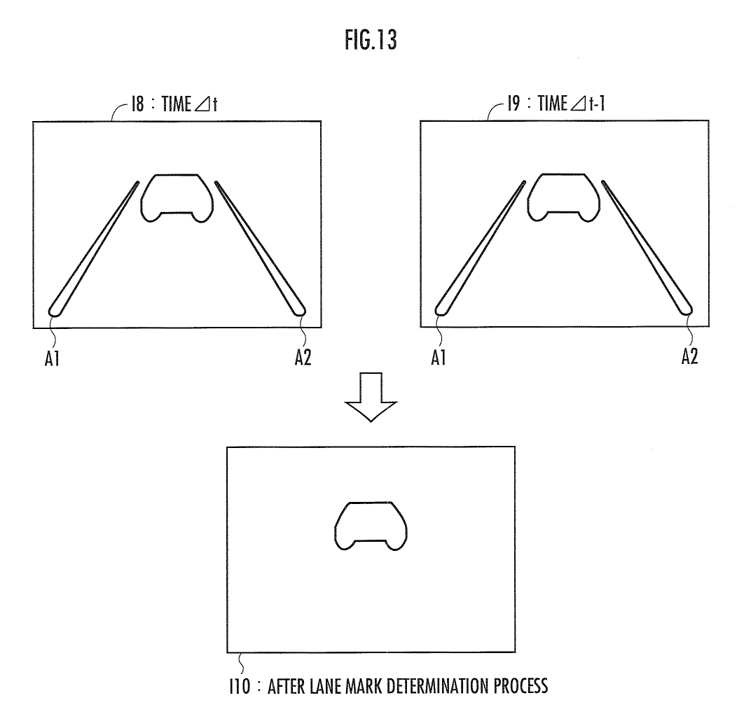

In the present embodiment, in STEP 2, the object detection unit 5 first provides the edge extraction process to the two images captured time-continuously, as with the sixth embodiment. In FIG. 13, an image I8 obtained by providing the edge extraction process to an image captured at time Δt, and an image I9 obtained by providing the edge extraction process to an image captured at time Δt−1, are illustrated. In the images I8 and I9, the profile line obtained from the edge points by the edge extraction process is indicated in black. Here, the region encircled by the profile line corresponds to the object.

Next, the object detection unit 5 compares the image I8 and the image I9, and calculates the change amount of the position between the object in the two images. Thereafter, the object detection unit 5 detects the object whose change amount of the position is smaller than a predetermined value as a candidate of the object other than the lane mark. Here, since the lane marks A1 and A2 are solid lines, there may be a case where the change in the shape of the road along which the vehicle 1 is traveling is small, and that the change of the position of the lane marks A1 and A2 between time Δt and time Δt−1 are not clearly reflected in the image, for example. And in such case, there is a possibility that the object detection unit 5 may erroneously determine the lane marks A1 and A2 as the object whose change amount of the position is smaller than the predetermined value.

In relation thereto, the object determination unit 14 determines whether the candidate detected by the object detection unit 5 is the lane mark or not, on the basis of the standard of the lane mark. The object determination unit 14 compares the standard data of the lane mark stored in advance with the data of the candidate of the object detected by the object detection unit 5, and determine whether or not the data of the candidate matches the standard. As the standard of the lane mark, for example, the width of the white line is set to 10 cm, the length of the white line is set to 8 m, the blank zone between the white line and the white line is set to 12 m, and the width of the lane is set to 3 m to 4 m, and the like. As such, the candidate corresponding to the lane marks A1 and A2 are determined as the lane mark.

Subsequently, the object detection unit 5 detects the candidate determined as not being the lane mark by the object portion determination unit 14 as the object other than the lane mark. The profile line corresponding to the object determined as not being the lane mark and whose change amount of the position is smaller than the predetermined value is illustrated in an image I10 of FIG. 13. As such, the data conforming to the standard of the lane mark may be removed on the basis of this standard, so that erroneously determined data may be deleted. By doing so, the pixel region R of the area corresponding to the preceding car B in the image I1 is specified as indicated in the image I2 of FIG. 3(b). The operations other than those described in the above are the same as in the sixth embodiment.

With the above process, it is possible to detect the white lines A1 and A2 from the image I1 of the road with good accuracy, by appropriately removing information related to the object other than the lane mark, such as a preceding car, so that the recognition accuracy of the lane may be improved, similarly to the sixth embodiment.

The present embodiment is an embodiment in which the edge extraction process is provided as the filtering process. As another embodiment, it may be an embodiment in which the optical flow process is provided similarly to the first embodiment.

Further, the present embodiment is an embodiment in which the object determination unit 14 is equipped in the sixth embodiment. As another embodiment, it may be an embodiment in which the object determination unit 14 is equipped in the first embodiment and the third embodiment.

Still further, in the third through the seventh embodiments, the candidate of the lane mark is extracted by providing the filtering process, and the removal process is executed to this candidate for the lane mark. However, for example, in the case where the candidate for the lane mark is extracted by a plurality of filtering processes, the lane mark candidate may be extracted by first executing the removal process to the data subjected to a predetermined filtering process, and then providing another filtering process to the data subjected to the removal process.

Still further, in the first to the seventh embodiments, for example, a technique of pattern matching using a reference shape of the lane mark may be used as the technique for extracting the lane mark candidate. Moreover, in the technique for extracting the lane mark candidate, a differentiation filter or a filter using the color information (such as the R value, G value, B value) in the Hough transformation, for example, may be used in combination thereto.

Still further, in the first to the seventh embodiments, the video camera 3 is configured to output the video signal in color image. However, this may be configured to output a video signal in black and white image.

### INDUSTRIAL APPLICABILITY

As seen from above, the present invention is capable of improving the recognition accuracy of the lane, by appropriately removing influence of subjects other than the lane mark captured in the image of the road, when recognizing the lane along which the vehicle is traveling by detecting the lane mark from the image of the road. Therefore, the present invention is useful in presenting information to the driver or controlling the vehicle behavior in the vehicle.

1. A lane recognition device which recognizes a lane along which a vehicle is traveling by detecting a lane mark on the road defining the lane, from an image of the road acquired via an imaging device mounted on the vehicle, comprising:
an object detection unit which detects an object other than the lane mark existing ahead of the vehicle; and
a lane mark detection unit which detects the lane mark on the basis of data obtained by removing the area corresponding to the object detected by the object detection unit from data related to the image of the road.

2. The lane recognition device according to claim 1, wherein the lane mark detection unit executes a removal process which removes the area corresponding to the object detected by the object detection unit to the acquired data of the image of the road, and detects the lane mark by providing a filtering process to the data of the image subjected to the removal process.

3. The lane recognition device according to claim 1, wherein the lane mark detection unit executes a removal process which removes the area corresponding to the object detected by the object detection unit to the data obtained by providing filtering process to the acquired image of the road, and detects the lane mark on the basis of the data subjected to the removal process.

4. The lane recognition device according to claim 1, wherein the lane mark detection unit comprises a lane mark type recognition unit which recognizes the type of the lane mark on the basis of the data obtained by providing the filtering process to the acquired image of the road, and a removal determination unit which determines whether or not to execute the removal process on the basis of the recognition result of the lane mark type recognition unit, and
in the case where the removal determination unit determines that the removal process should be executed, the lane mark detection unit executes the removal process which removes the area corresponding to the object detected by the object detection unit to the data obtained by providing filtering process to the acquired image of the road, and detects the lane mark on the basis of the data subjected to the removal process.

5. The lane mark recognition device according to claim 1, wherein the object detection unit detects the object other than the lane mark on the basis of a detection result by a distance sensor mounted on the vehicle.

6. The lane mark recognition device according to claim 1, wherein the object detection unit detects the object by providing the filtering process to the acquired image.

7. The lane recognition device according to claim 6, wherein the object detection unit provides an optical flow process to the acquired image as the filtering process, calculates a change amount of a relative position of the object to the vehicle within the image, and detects the object whose calculated change amount of the relative position is smaller than a predetermined value as the object other than the lane mark.

8. The lane recognition device according to claim 6, wherein the object detection unit provides an edge extraction process to two images acquired time-continuously via the imaging device as the filtering process, calculates a change amount of a position between the object within the two images, and detects the object whose calculated change amount of the position is smaller than a predetermined value as the object other than the lane mark.

9. The lane recognition device according to claim 6, comprising an object determination unit which determines whether or not the object is the lane mark on the basis of the standard of the lane mark on the road,
wherein the object detection unit executes the process which detects the object other than the lane mark by providing the filtering process to the acquired image, and determines, from candidates of the object other than lane mark detected as a result of the process, the candidate determined not as a lane mark by the object determination unit as the object other than the lane mark.

10. A vehicle to which the lane recognition device according to claim 1 is mounted.

11. A lane recognition method which recognizes a lane along which a vehicle is traveling by detecting a lane mark on the road defining the lane, from an image of the road acquired via an imaging device mounted on the vehicle, comprising the steps of:
an object detection step which detects an object other than the lane mark existing ahead of the vehicle; and
a lane mark detection step which detects the lane mark on the basis of data obtained by removing the area corresponding to the object detected in the object detection step from data related to the image of the road.

12. A lane recognition program which makes a computer execute the process which recognizes a lane along which a vehicle is traveling by detecting a lane mark on the road defining the lane, from an image of the road acquired via an imaging device mounted on the vehicle, comprising the functions of making the computer execute the process of:
an object detection process which detects an object other than the lane mark existing ahead of the vehicle; and
a lane mark detection process which detects the lane mark on the basis of data obtained by removing the area corresponding to the object detected in the object detection step from data related to the image of the road.
